(19) United States
(12) Patent Application Publication
(10) Pub. No.: US 2018/0272556 A1
(43) Pub. Date: Sep. 27, 2018

(54) Power Tool Separation Device

(71) Applicant: Robert Bosch GmbH, Stuttgart (DE)

(72) Inventors: Rudolf Fuchs, Neuhausen (DE); Petr Grulich, Kirchheim/Teck (DE); Uwe Engelfried, Ostfildern (DE)

(21) Appl. No.: 15/994,280

(22) Filed: May 31, 2018

Related U.S. Application Data
(62) Division of application No. 14/001,585, filed on Oct. 30, 2013.

(30) Foreign Application Priority Data
Mar. 3, 2011 (DE) 10 2011 005 011.6

(51) Int. Cl. B27B 33/14; B27B 17/02

(52) U.S. Cl. CPC B27B 33/148; B27B 33/147; B27B 33/14; B27B 17/02; Y10T 83/913

(57) ABSTRACT

The disclosure relates to a power tool separation device, in particular a hand-held power tool separation device, comprising at least one cutting unit which comprises at least two interconnected cutter support elements. At least two cutter support elements are interconnected by means of at least one connecting element of the cutting unit, and the connecting element is essentially flush with at least one outer surface of the at least two cutter support elements.

### CLAIM OF PRIORITY

This application is a divisional of co-pending U.S. patent application Ser. No. 14/001,585, filed on Oct. 30, 2013, the entire disclosure of which is incorporated herein by reference, and which is a 35 U.S.C. § 371 National Stage Application of PCT/EP2012/000939, filed on Mar. 2, 2012, which claims the benefit of priority to Serial No. DE 10 2011 005 011.6, filed on Mar. 3, 2011 in Germany, the disclosures of which are incorporated herein by reference in their entirety.

### BACKGROUND

Power tool separation devices, in particular hand-held power tool separation devices, that have a cutting assembly which comprises at least two interconnected cutter support elements are already known.

### SUMMARY

The disclosure relates to a power tool separation device, in particular a hand-held power tool separation device, having at least one cutting assembly which comprises at least two interconnected cutter support elements.

It is proposed for the at least two cutter support elements to be interconnected by means of at least one connecting element of the cutting assembly, said connecting element terminating at least substantially flush with at least one outer face of one of the at least two cutter support elements. Here, a “cutting assembly” is to be understood in particular to mean a unit that is provided to locally cancel an atomic bond of a workpiece to be machined, in particular by means of a mechanical detachment and/or by means of a mechanical removal of material particles of the workpiece. The cutting assembly is preferably provided to separate the workpiece into at least two parts physically separated from one another and/or to detach and/or to remove, at least in part, material particles of the workpiece starting from a surface of the workpiece. The cutting assembly is particularly preferably moved in a circulating manner in at least one operating state, in particular along a peripheral direction of a guide unit of the power tool separation device. Here, a “cutter support element” is to be understood in particular to mean an element, on which at least one cutting element for detaching and/or for removing material particles of a workpiece to be machined is arranged. The term “connecting element” is intended here in particular to define an element that is provided to interconnect at least two component parts in a form-locked and/or force-locked manner, in particular to interconnect said component parts movably so as to transmit a driving force and/or a driving torque. In this context, the term “provided” is to be understood in particular to mean specifically designed and/or specifically equipped. Here, the expression “terminate at least substantially flush” is to be understood in particular to mean an arrangement of the connecting element in an assembled state, wherein the connecting element, in the case of a connecting element formed separately from the cutter support elements, considered along a longitudinal axis of the connecting element, and in the case of a connecting element formed in one piece with one of the cutter support elements, considered along a transverse axis of the connecting element, extends within the at least one connecting recess receiving the connecting element and extends at most as far as an outer surface of the cutter support element which comprises the connecting recess. The connecting element in an assembled state, in particular in the case of a connecting element formed separately from the cutter support elements, particularly preferably extends at most from an outer face of one of the cutter support elements to a further outer face of one of the cutter support elements. By means of the embodiment according to the disclosure, a compact power tool separation device can be achieved advantageously.

Furthermore, it is proposed for the connecting element to be formed at least partly in one piece with at least one of the at least two cutter support elements. Here, the term “in one piece” is to be understood in particular to mean connected at least in a force-locked manner, for example by means of a welding process, an adhesive bonding process, an injection process and/or another process appearing sensible to a person skilled in the art, and/or is advantageously to be understood to mean formed in one piece, for example by means of production from a cast part and/or by means of production in a conventional or multi-component injection molding method and advantageously from an individual blank. The cutter support elements particularly preferably each have a connecting element and a connecting recess for receiving a connecting element of a further cutter support element connectable to the respective cutter support element. In an alternative embodiment of the power tool separation device according to the disclosure, the connecting element is formed as a component formed separately from the cutter support elements. In this case, the cutter support elements preferably each have two connecting recesses, into each of which a connecting element can be inserted. By means of the one-piece embodiment of the connecting element, an assembly effort can advantageously be kept low.

The connecting element is preferably formed as a longitudinal extension of at least one of the at least two cutter support elements. Each cutter support element of the cutting assembly particularly preferably has at least one connecting element formed as a longitudinal extension and one connecting recess corresponding to the connecting element. Here, a “longitudinal extension” is to be understood in particular to mean an element that is formed in one piece with the cutter support element and that extends at least substantially along a longitudinal extension of the cutter support element and that is provided, in a state connected to a further cutter support element, to provide a connection, in particular a form-locked connection. In this case, a movable connection, in particular a pivotable connection, of the cutter support elements relative to one another is provided by means of a cooperation between the longitudinal extension of the cutter support element and the connecting recess, formed in a manner corresponding to the longitudinal extension, in the further cutter support element. The longitudinal extension of the cutter support element preferably runs at least substantially parallel to a primary direction of movement of the cutter support element, along which the cutter support element is moved in order to make a cut, etc. by means of a cutting element arranged on the cutter support element. Here, the expression “substantially parallel” is to be understood in particular to mean an orientation of a direction relative to a reference direction, in particular in a plane, wherein the direction has a deviation with respect to the reference direction in particular of less than 8°, advantageously less than 5°, and particularly advantageously less than 2°. An easily assembled connection between the cutter support elements can advantageously be provided by means of the embodiment according to the disclosure.

The longitudinal extension is advantageously hook-shaped. Here, “hook-shaped” is to be understood in particular to mean a geometric embodiment of the longitudinal extension which, considered along the longitudinal extension of the cutter support element, enables an edge region of the connecting recess to be engaged from behind by means of the longitudinal extension in an interconnected state of the cutter support elements. In this case, the longitudinal extension, considered in the cutting plane of the cutting assembly, is formed in particular in a manner deviating from a rod-shaped extension, on which a circular form-locking element is formed and/or in particular in a manner deviating from a semi-circular shape. A transmission of driving forces, in particular tractive forces, can be enabled with a simple construction.

Furthermore, it is proposed in an alternative embodiment of the power tool separation device, for the connecting element to be formed as a pin. The pin is preferably cylindrical. The pin is particularly preferably formed so as to be rotationally symmetrical about at least one axis. In this case, the connecting element formed as a pin can be formed in one piece with or separately from the cutter support element. It is also conceivable however for the connecting element to have a different embodiment appearing sensible to a person skilled in the art. A connecting element can be achieved with a simple construction.

In addition, it is proposed for at least one of the at least two cutter support elements to have at least one transverse securing element, which is provided to at least largely prevent a transverse movement of the cutter support elements relative to one another in a coupled state of the cutter support elements. Each cutter support element of the power tool separation device preferably comprises at least two transverse securing elements. In this case, the at least two transverse securing elements are provided to at least largely prevent a relative transverse movement of the interconnected cutter support elements in two oppositely directed directions. One of the at least two transverse securing elements is thus preferably provided to at least largely prevent a transverse movement running along one of the oppositely directed directions. The at least two transverse securing elements are preferably arranged on the cutter support element so as to be offset, in particular angularly offset, relative to one another. The expression “to at least largely prevent a transverse movement of the cutter support elements relative to one another in a coupled state” is to define here in particular a delimitation of a movement relative to one another of the cutter support elements, connected to one another by means of connecting elements, by means of the transverse securing element along a movement path running at least substantially perpendicular to a longitudinal axis of the cutter support elements. The movement path of the cutter support elements relative to one another is delimited in this case in particular by means of the transverse securing element to a value less than 5 mm, preferably less than 2 mm and particularly preferably less than 1 mm. The transverse securing element is preferably provided to at least largely avoid or to delimit a transverse movement by means of a form-locked connection. It is also conceivable however for the transverse securing element to be provided to at least largely avoid or to delimit a transverse movement by means of another method appearing sensible to a person skilled in the art, for example by means of a force-locked connection. By means of the embodiment according to the disclosure, a lateral offset of the cutter support elements relative to one another can advantageously be at least largely prevented during operation, in particular as a cut is made, etc. A precise result can thus be achieved advantageously.

The transverse securing element is particularly preferably formed integrally on the at least one of the at least two cutter support elements by means of a stamping method. It is also conceivable however for the transverse securing element to be arranged on the cutter support element by means of another method appearing sensible to a person skilled in the art, for example by means of a casting method, by means of an adhesive bonding method, by means of a soldering method, by means of a milling method, etc. By means of a forming of the transverse securing element by a stamping method, the transverse securing element can be formed subsequent to manufacture of the cutter support element. The transverse securing element can additionally be formed advantageously in a cost-effective manner.

Furthermore, it is proposed for at least one of the at least two cutter support elements to have at least one segment guide element, which is provided to delimit a movement of the at least one of the at least two cutter support elements, in a state arranged in a guide unit, considered in a direction remote from the guide unit, at least along a direction running at least substantially parallel to a cutting plane of the cutting assembly. Each cutter support element of the cutting assembly of the power tool separation device particularly preferably has at least one segment guide element, which is provided to delimit a movement of the at least one of the at least two cutter support elements, in a state arranged in a guide unit, considered in a direction remote from the guide unit, at least along a direction running at least substantially parallel to a cutting plane of the cutting assembly. The power tool separation device preferably has a least one guide unit for receiving the cutting assembly, said guide unit comprising at least one segment counter guide element corresponding to the segment guide element. Guidance along a direction of the cutting assembly running at least substantially parallel to a cutting plane of the cutting assembly can thus be achieved with a simple construction.

The power tool separation device advantageously has at least one guide unit for receiving the cutting assembly, the connecting element being guided at least in part in said guide unit. Here, a “guide unit” is to be understood in particular to mean a unit that is provided to exert on the cutting assembly a coercive force at least along a direction perpendicular to a cutting direction of the cutting assembly so as to predefine a possibility for movement of the cutting assembly along the cutting direction. The guide unit preferably has at least one guide element, in particular a guide groove, by means of which the cutting assembly is guided. The cutting assembly, considered in a cutting plane, is preferably guided along a total periphery of the guide unit by the guide unit by means of the guide element, in particular the guide groove. Here, the term “cutting plane” is to define in particular a plane in which the cutting assembly is moved relative to the guide unit in at least one operating state along a periphery of the guide unit in at least two oppositely directed cutting directions. The cutting plane, as a workpiece is machined, is preferably oriented at least substantially transverse to a workpiece surface to be machined. Here, the expression “at least substantially transverse” is to be understood in particular to mean an orientation of a plane and/or of a direction relative to a further plane and/or a further direction, which preferably deviates from a parallel orientation of the plane and/or the direction relative to the further plane and/or the further direction. It is also conceivable however for the cutting plane, as a workpiece is machined, to be aligned at least substantially parallel to a workpiece surface to be machined, in particular in the event that the cutting assembly is formed as a grinding means, etc. Here, the expression “at least substantially parallel” is to be understood in particular to mean an orientation of a direction relative to a reference direction, in particular in a plane, wherein the direction has a deviation with respect to the reference direction in particular of less than 8°, advantageously of less than 5°, and particularly advantageously of less than 2°.

Here, a “cutting direction” is to be understood in particular to mean a direction along which the cutting assembly is moved in order to generate a cutting gap and/or to detach and/or to remove material particles of a workpiece to be machined in at least one operating state as a result of a driving force and/or a driving torque, in particular in the guide unit. The cutting assembly is preferably moved in an operating state along the cutting direction relative to the guide unit. The cutting assembly and the guide unit preferably together form a closed system. The guide unit preferably has a geometric design that, considered in the cutting plane, has a closed outer contour comprising at least two straight lines running parallel to one another and at least two connecting portions, in particular circular arcs, interconnecting ends of the straight lines facing towards one another. Here, the term “closed system” is to define in particular a system that comprises at least two components which, by means of a cooperation, maintain a functionality in a state of the system disassembled from another system superordinate to the aforesaid system, such as a power tool, and/or which are inseparably interconnected in the disassembled state. The at least two components of the closed system are preferably interconnected in a manner that is at least substantially inseparable for a user. Here, the expression “at least substantially inseparable” is to be understood here in particular to mean a connection of at least two component parts that can only be separated from one another with the aid of separation tools, such as a saw, in particular a mechanical saw etc., and/or chemical separation means, such as solvents, etc. By means of the embodiment of the power tool separation device according to the disclosure, the cutting assembly can be guided with a simple construction.

In addition, it is proposed for the power tool separation device to comprise at least one torque transmission element mounted at least in part in the guide unit. The torque transmission element is preferably surrounded at least in part by side walls of the guide unit along at least one direction. The torque transmission element preferably has a concentric coupling recess, in which a pinion of a drive unit of a portable power tool and/or a gearwheel and/or a toothed shaft of a gear unit of the portable power tool can engage in an assembled state. In this case, the coupling recess is preferably formed by a hexagon socket. It is also conceivable however for the coupling recess to have another embodiment appearing sensible to a person skilled in the art. By the means of the embodiment of the power tool separation device according to the disclosure, a closed system that can be assembled comfortably by a user on a power tool provided for this purpose can be achieved with a simple construction. It is therefore advantageously possible to dispense with an individual assembly by the user of components, such as the cutting assembly, the guide unit and the torque transmission element, for use of the power tool separation device according to the disclosure.

At least one of the at least two cutter support elements, on a side of the cutter support element facing towards the torque transmission element, advantageously has at least one recess, in which the torque transmission element engages in at least one operating state for driving the cutting assembly. All cutter support elements of the cutting assembly, on the sides of the cutter support elements facing towards the torque transmission element, preferably have at least one recess, in which the torque transmission element engages in at least one operating state for driving the cutting assembly. Forces and/or torques for driving the cutting assembly can be transmitted to the cutter support element with a simple construction.

Furthermore, it is proposed for at least one of the at least two cutter support elements to be formed at least substantially in a circular-arc-shaped manner on a side of the cutter support element facing towards a torque transmission element mounted at least in part in the guide unit. The side of the at least one of the at least two cutter support elements facing towards the torque transmission element in an assembled state is formed in a circular-arc-shaped manner in particular in at least one sub-region, considered between a center axis of the connecting element arranged in and/or on the respective cutter support element and a center axis of a connecting recess of the respective cutter support element for receiving the connecting element. The circular-arc-shaped sub-region is preferably formed adjacently to the recess in which the torque transmission element engages. The circular-arc-shaped sub-region particularly preferably has a radius that corresponds at least substantially to a radius of a deflection contour of the guide unit, in particular of a deflection contour of a guide element of the guide unit arranged at a convex end. The side of the cutter support element facing towards the torque transmission element in an assembled state, in particular the sub-region, is preferably concave. A deflection of the cutter support element during operation of the power tool separation device can advantageously be achieved. A small deflection radius with a deflection of the cutter support element can also advantageously be provided.

The connecting element advantageously has a porous structure. Here, a “porous structure” is to be understood in particular to mean a structure that has a multiplicity of cavities, which are arranged within an overall volume of a body and/or of a material and thus influences a density of the body and/or of the material. The porous structure is preferably formed by pores of the connecting element that are arranged in the connecting element. In particular, the connecting element has a pore density that is greater than 10 ppi (pores per inch), preferably greater than 35 ppi and particularly preferably greater than 50 ppi. The connecting element particularly preferably has an open porosity. Here, an “open porosity” is to be understood in particular to mean a connection of the cavities and/or the pores to one another and a cooperation of the cavities and/or of the pores with the environment adjacent to the connecting element. By means of the porous structure, the connecting element can advantageously be saturated with lubricant, for example. A service life can thus advantageously be increased, and a maintenance intensity can advantageously be reduced.

Furthermore, the disclosure relates to a portable power tool comprising a coupling device for form-locked and/or force-locked coupling to a power tool separation device according to the disclosure. Here, a “portable power tool” is to be understood in particular to mean a power tool, in particular a hand-held power tool, which can be transported by an operator without the use of a transporting machine. The portable power tool in particular has a mass that is less than 40 kg, preferably less than 10 kg, and particularly preferably less than 5 kg. The power tool separation device according to the disclosure and the portable power tool according to the disclosure particularly preferably form a power tool system. A portable power tool that is particularly advantageously suitable for a broad spectrum of use can advantageously be achieved.

The power tool separation device according to the disclosure and/or the portable power tool according to the disclosure are not to be limited in this case to the above-described application and embodiment. In particular, the power tool separation device according to the disclosure and/or the portable power tool according to the disclosure can have a number of individual elements, components and units deviating from a number mentioned herein in order to fulfill a functionality described herein.

### BRIEF DESCRIPTION OF THE DRAWINGS

Further advantages will emerge from the following description of the drawing. Exemplary embodiments of the disclosure are illustrated in the drawing. The drawing, the description and the claims contain numerous features in combination. A person skilled in the art will also expediently consider the features individually and combine them to form meaningful further combinations.

In the drawings:

FIG. 1 shows a schematic illustration of a portable power tool according to the disclosure with a power tool separation device according to the disclosure,

FIG. 2 shows a schematic illustration of a detail of the power tool separation device according to the disclosure,

FIG. 3 shows a schematic illustration of a detail of cutter support elements of a cutting assembly of the power tool separation device according to the disclosure,

FIG. 4 shows a schematic illustration of a further detail of one of the cutter support elements of the cutting assembly of the power tool separation device according to the disclosure,

FIG. 5 shows a schematic illustration of a detail of an arrangement of the cutter support element in a guide unit of the power tool separation device according to the disclosure,

FIG. 6 shows a schematic illustration of a detail of an alternative power tool separation device according to the disclosure,

FIG. 7 shows a schematic illustration of a detail of cutter support elements of a cutting assembly of the alternative power tool separation device according to the disclosure,

FIG. 8 shows a schematic illustration of a detail of an arrangement of the cutter support elements in a guide unit of the alternative power tool separation device according to the disclosure,

FIG. 9 shows a schematic illustration of a detail of cutter support elements of a cutting assembling of a further, alternative power tool separation device according to the disclosure,

FIG. 10 shows a schematic illustration of a sectional view of the cutter support elements along the line X-X from FIG. 9,

FIG. 11 shows a schematic illustration of a detail of an assembly position of the cutter support elements from FIG. 9,

FIG. 12 shows a schematic illustration of a detail of cutter support elements of a cutting assembly of a further, alternative power tool separation device according to the disclosure,

FIG. 13 shows a schematic illustration of a sectional view of the cutter support elements along the line XIII-XIII from FIGS. 12, and

FIG. 14 shows a schematic illustration of a detail of an assembly position of the cutter support elements from FIG. 12.

### DETAILED DESCRIPTION

FIG. 1 shows a portable power tool 42a with a power tool separation device 10a, which together form a power tool system. The portable power tool 42a has a coupling device 44a for form-locked and/or force-locked coupling to the power tool separation device 10a. The coupling device 44a can be formed in this case as a bayonet closure and/or as another coupling device appearing sensible to a person skilled in the art. Furthermore, the portable power tool 42a comprises a power tool housing 46a, which encloses a drive unit 48a and a gear unit 50a of the portable power tool 42a. The drive unit 48a and the gear unit 50a are functionally interconnected in a manner already known to a person skilled in the art for generation of a driving torque that can be transmitted to the power tool separation device 10a. The gear unit 50a is formed as a bevel gear. The drive unit 48a is formed as an electric motor unit. It is also conceivable however for the drive unit 48a and/or the gear unit 50a to have a different embodiment appearing sensible to a person skilled in the art. The drive unit 48a is provided to drive a cutting assembly 12a of the power tool separation device 10a in at least one operating state at a cutting rate less than 6 m/s. In this case, the portable power tool 42a has at least one operating mode, in which it is possible to drive the cutting assembly 12a in a guide unit 30a of the power tool separation device 10a along a cutting direction 52a of the cutting assembly 12a at a cutting rate less than 6 m/s.

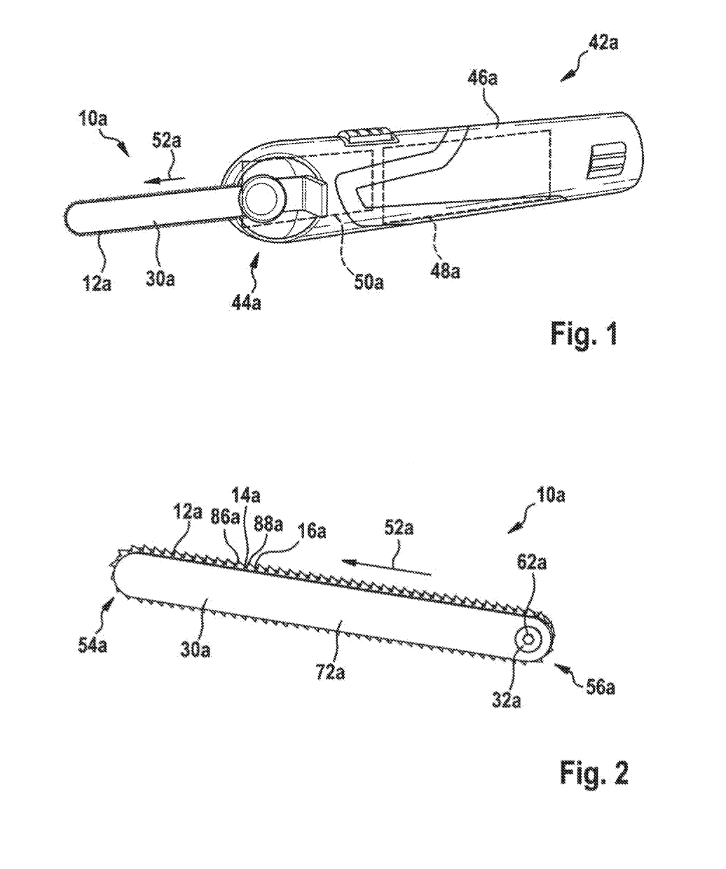

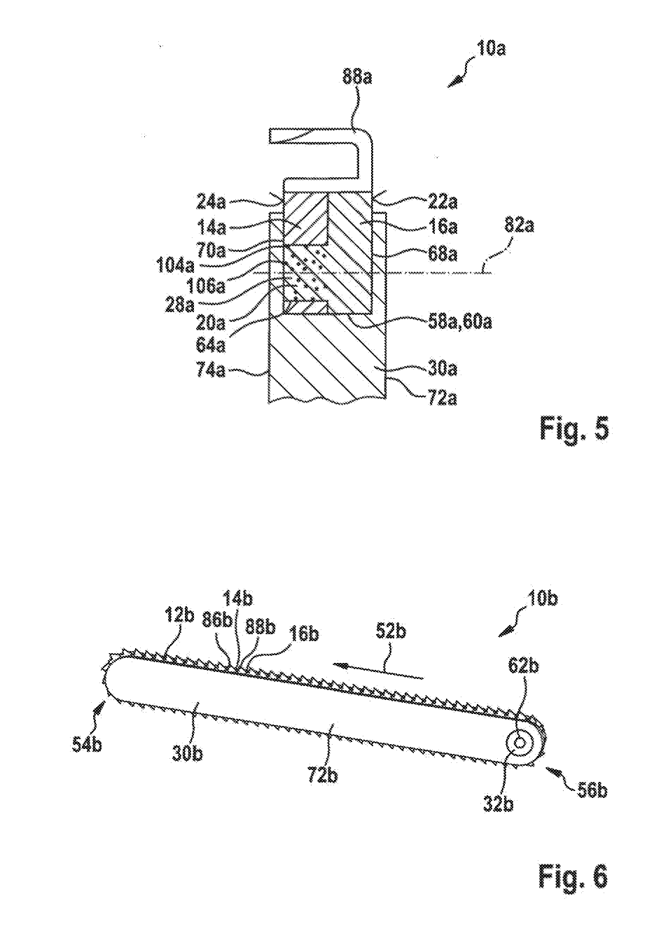

FIG. 2 shows the power tool separation device 10a in a state decoupled from the coupling device 44a of the portable power tool 42a. The power tool separation device 10a comprises the cutting assembly 12a and the guide unit 30a, which together form a closed system. The guide unit 30a is formed as a nose bar. Furthermore, the guide unit 30a, considered in a cutting plane of the cutting assembly 12a, has at least two convex ends 54a, 56a. The convex ends 54a, 56a of the guide unit 30a are arranged on two sides of the guide unit 30a remote from one another. The cutting assembly 12a is guided by means of the guide unit 30a. To this end, the guide unit 30a has at least one guide element 58a (FIG. 5), by means of which the cutting assembly 12a is guided. The guide element 58a is formed in this case as a guide groove 60a, which extends in a cutting plane of the cutting assembly 12a along a total periphery of the guide unit 30a. In this case, the cutting assembly 12a is guided by means of edge regions of the guide unit 30a delimiting the guide groove 60a. It is also conceivable however for the guide element 58a to be formed in another manner appearing sensible to a person skilled in the art, for example as a rib-like formation on the guide unit 30a, said formation engaging in a recess on the cutting assembly 12a. The cutting assembly 12a, considered in a plane running perpendicular to the cutting plane, is surrounded on three sides by the edge regions delimiting the guide groove 60a (FIG. 5). During operation, the cutting assembly 12a is moved relative to the guide unit 30a in a circulating manner along the periphery of the guide unit 30a in the guide groove 60a.

Furthermore, the power tool separation device 10a has a torque transmission element 32a mounted by means of the guide unit 30a for driving the cutting assembly 12a. The torque transmission element 32a is surrounded in an assembled state, considered in a plane running perpendicular to the cutting plane, by two outer walls 72a, 74a of the guide unit 30a. Furthermore, in a coupled state, the torque transmission element 32a is coupled to the drive of the cutting assembly 12a by means of a pinion (not illustrated here in greater detail) of the drive unit 48a and/or a gearwheel (not illustrated here in greater detail) and/or a toothed shaft (not illustrated here in greater detail) of the gear unit 50a. In this case, the torque transmission element 32a has a coupling recess 62a, which can be coupled in an assembled state to a drive element of the portable power tool 42a. The coupling recess 62a is arranged concentrically in the torque transmission element 32a. The coupling recess 62a is also provided so as to be coupled in a coupled state of the torque transmission element 32a and/or of the power tool separation device 10a to the pinion (not illustrated here in greater detail) of the drive unit 48a and/or the gearwheel (not illustrated here in greater detail) and/or the toothed shaft (not illustrated here in greater detail) of the gear unit 50a. The coupling recess 62a is formed as a hexagon socket. It is also conceivable however for the coupling recess 62a to have a different embodiment appearing sensible to a person skilled in the art.

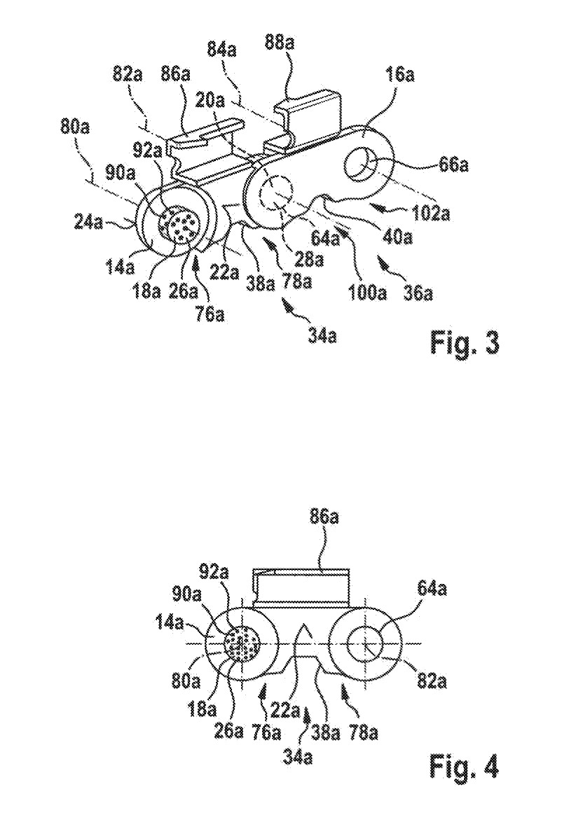

The cutting assembly 12a has a multiplicity of interconnected cutter support elements 14a, 16a, which are each interconnected by means of a connecting element 18a, 20a of the cutting assembly 12a, said connecting element terminating at least substantially flush with one of two outer faces 22a, 24a of one of the interconnected cutter support elements 14a, 16a (FIG. 3). The outer faces 22a, 24a run, in a state of the cutting assembly 12a arranged in the guide groove 60a, at least substantially parallel to the cutting plane. Depending on the application, a person skilled in the art will select a number of cutter support elements 14a, 16a suitable for the cutting assembly 12a. In FIG. 3, merely two interconnected cutter support elements 14a, 16a are illustrated, which are interconnected by means of one of the connecting elements 18a, 20a. The connecting elements 18a, 20a are formed as pins 26a, 28a. In this case, the connecting elements 18a, 20a are each formed in one piece with one of the cutter support elements 14a, 16a. The cutter support elements 14a, 16a each have a connecting recess 64a, 66a for receiving one of the connecting elements 18a, 20a of the interconnected cutter support elements 14a, 16a. The connecting elements 18a, 20a are guided by means of the guide unit 30a (FIG. 5). In this case, the connecting elements 18a, 20a are arranged in the guide groove 60a in an assembled state of the cutting assembly 12a. The connecting elements 18a, 20a, considered in a plane running perpendicular to the cutting plane, can be supported on two side walls 68a, 70a of the guide groove 60a. The side walls 68a, 70a of the guide groove 60a, considered in the cutting plane, extend outwardly starting from the guide unit 30a, perpendicular to the cutting device 52a of the cutting assembly 12a. The side walls 68a, 70a are also formed in one piece with the outer walls 72a, 74a of the guide unit 30a.

Furthermore, the connecting elements 18a, 20a have a porous structure. In this case, the connecting elements 18a, 20a each have a multiplicity of cavities 90a, 92a, 104a, 106a, which are arranged within total volumes of the connecting elements 18a, 20a. The cavities 90a, 92a, 104a, 106a are formed as pores. The cavities 90a, 92a, 104a, 106a can in this case be distributed uniformly and/or non-uniformly in the total volumes in the connecting elements 18a, 20a. The connecting elements 18a, 20a are each saturated with a lubricant (not illustrated here in greater detail), which is provided to lubricate a lubrication of the connecting elements 18a, 20a arranged movably in the connecting recesses 64a, 66a and in the guide groove 60a. The lubricant is in this case arranged in the cavities 90a, 92a, 104a, 106a, formed as pores, in the connecting elements 18a, 20a.

The cutter support elements 14a, 16a of the cutting assembly 12a further each have a recess 38a, 40a, which is arranged in each case in an assembled state on a side 34a, 36a of the respective cutter support element 14a, 16a facing towards the torque transmission element 32a. The torque transmission element 32a engages in the recesses 38a, 40a in at least one operating state for driving the cutting assembly 12a. The torque transmission element 32a is formed in this case as a gearwheel. The torque transmission element 32a thus comprises teeth (not illustrated here in greater detail), which are provided to engage in the recesses 38a, 40a of the cutter support elements 14a, 16a in at least one operating state for driving the cutting assembly 12a. Furthermore, the sides 34a, 36a of the cutter support elements 14a, 16a facing towards the torque transmission element 32a are formed in a circular-arc-shaped manner. The sides 34a, 36a of the cutter support elements 14a, 16a facing towards the torque transmission element 32a in an assembled state are each formed in a circular-arc-shaped manner in sub-regions 76a, 78a, 100a, 102a, considered between a center axis 80a of the respective connecting element 18a, 20a and a center axis 82a, 84a of the respective connecting recess 64a, 66a. The circular-arc-shaped sub-regions 76a, 78a, 100a, 102a are each formed adjacent to the recesses 38a, 40a, in which the torque transmission element 32a engages. In this case, the circular-arc-shaped sub-regions 76a, 78a, 100a, 102a have a radius that corresponds to a radius of a course of the guide groove 60a on the convex ends 54a, 56a. The sub-regions 76a, 78a, 100a, 102a are concave (FIGS. 3 and 4).

Furthermore, the cutting assembly 12a has cutting elements 86a, 88a. The cutting elements 86a, 88a are each formed in one piece with one of the cutter support elements 14a, 16a. A number of the cutting elements 86a, 88a is dependent on a number of cutter support elements 14a, 16a. A person skilled in the art will select a suitable number of cutting elements 86a, 88a depending on the number of cutter support elements 14a, 16a. The cutting elements 86a, 88a are provided to enable a detachment and/or a removal of material particles of a workpiece to be machined (not illustrated here in greater detail). The cutting elements 86a, 88a can be formed for example as full chisels, as semi-chisels, or other cutting types appearing sensible to a person skilled in the art that are provided to enable a detachment and/or a removal of material particles of a workpiece to be machined. The cutting assembly 12a is formed endlessly. The cutting assembly 12a is thus formed as a cutting chain. The cutter support elements 14a, 16a are formed in this case as chain links, which are interconnected by means of the pin-shaped connecting elements 18a, 20a. It is also conceivable however for the cutting assembly 12a, the cutter support elements 14a, 16a and/or the connecting elements 18a, 20a to be formed in another manner appearing sensible to a person skilled in the art.

Alternative exemplary embodiments are illustrated in FIGS. 6 to 16. Substantially unchanged components, features and functions are referenced in principle with the same reference signs. The letters a to d have been added to the reference signs in the exemplary embodiments in order to distinguish therebetween. The following description is limited substantially to the differences from the first exemplary embodiment in FIGS. 1 to 5, wherein reference can be made to the description of the first exemplary embodiment in FIGS. 1 to 5 with regard to unchanged components, features and functions.

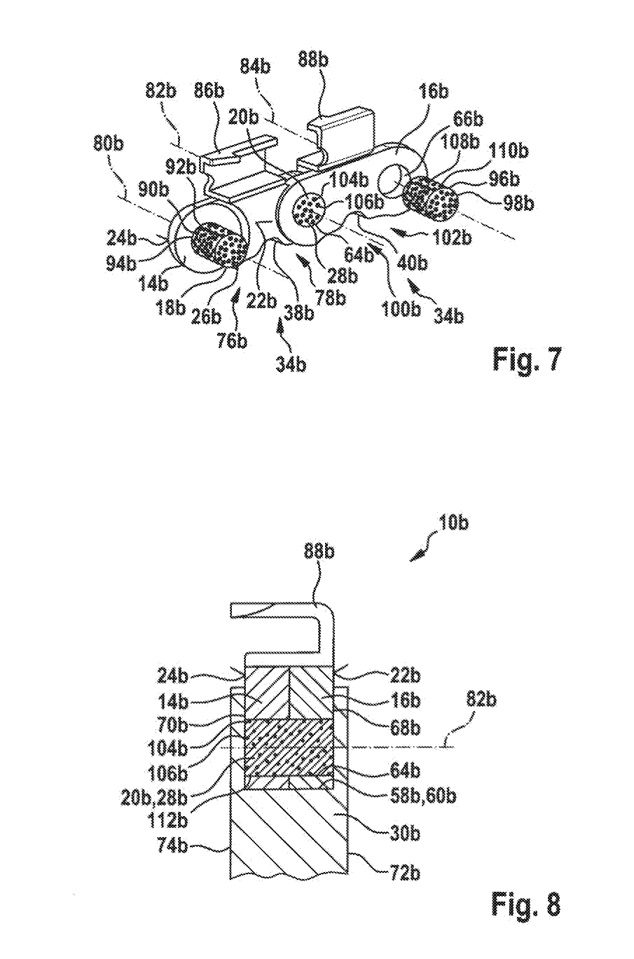

FIG. 6 shows an alternative power tool separation device 10b, which has a cutting assembly 12b, which comprises a multiplicity of interconnected cutter support elements 14b, 16b. The power tool separation device 10b can be functionally coupled to a coupling device (not illustrated here in greater detail) of a portable power tool (not illustrated here in greater detail). The portable power tool and the coupling device in this case have a structure similar to the exemplary embodiment that has been described in FIGS. 1 to 5. The cutter support elements 14b, 16b are each interconnected by means of a connecting element 18b, 20b, 96b of the cutting assembly 12b (FIG. 7). In this case, the connecting elements 18b, 20b, 96b terminate at least substantially flush with outer faces 22b, 24b of the cutter support elements 14b, 16b in an assembled state (FIGS. 7 and 8). The connecting elements 18b, 20b, 96b are formed as pins 26b, 28b, 98b. Furthermore, the connecting elements 18b, 20b 96b are formed separately from the cutter support elements 14b, 16b.

When the cutting assembly 12b is assembled, the cutter support elements 14b, 16b are interconnected by means of the connecting elements 18b, 20b, 96b. In this case, the connecting elements 18b, 20b 96b are introduced in connecting recesses 64b, 66b, 94b, 112b in the cutter support elements 14b, 16b until the connecting elements 18b, 20b terminate at least substantially flush with the outer faces 22b, 24b of the cutter support elements 14b, 16b. The connecting elements 18b, 20b, 96b are guided by means of the guide unit 30b in an assembled state of the cutting assembly 12b in a guide unit 30b of the power tool separation device 10b (FIG. 8). In this case, the connecting elements 18b, 20b, 96b are arranged in a guide groove 60b of the guide unit 30b in an assembled state of the cutting assembly 12b. The connecting elements 18b, 20b, 96b can be supported, considered in a plane running perpendicular to a cutting plane, on two side walls 68b, 70b of the guide groove 60b. The side walls 68b, 70b of the guide groove 60b extend, considered in the cutting plane, outwardly starting from the guide unit 30b, perpendicular to a cutting direction 52b of the cutting assembly 12b. Furthermore, the side walls 68b, 70b are formed in one piece with outer walls 72b, 74b of the guide unit 30b.

Furthermore, the connecting elements 18b, 20b, 96b have a porous structure. In this case, the connecting elements 18b, 20b, 96b each have a multiplicity of cavities 90b, 92b, 104b, 106b, 108b, 110b, which are arranged within total volumes of the connecting elements 18b, 20b, 96b. The cavities 90b, 92b, 104b, 106b, 108b, 110b are formed as pores. The cavities 90b, 92b, 104b, 106b, 108b, 110b can be distributed in this case uniformly and/or non-uniformly in the total volumes of the connecting elements 18b, 20b, 96b. The connecting elements 18b, 20b, 96b are each saturated with a lubricant (not illustrated here in greater detail), which is provided to lubricate a lubrication of the connecting elements 18b, 20b, 96b arranged movably in the connecting recesses 64b, 66b, 94b, 112b and in the guide groove 60b. The lubricant is in this case arranged in the cavities 90b, 92b, 104b, 106b, 108b, 110b, formed as pores, in the connecting elements 18b, 20b, 96b.

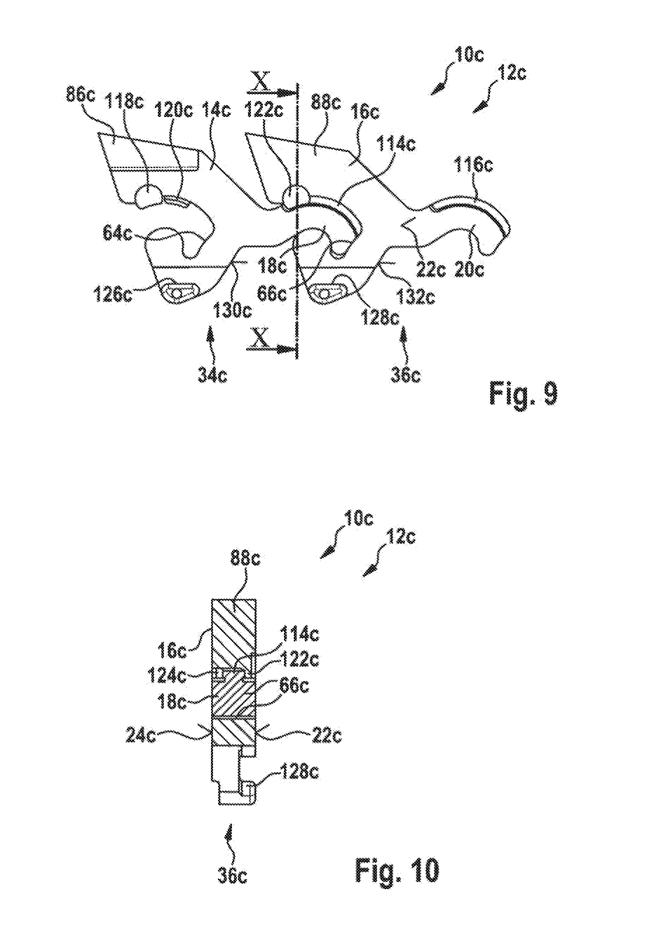

FIG. 9 shows two cutter support elements 14c, 16c, coupled to one another, of a cutting assembly 12c of a further, alternative power tool separation device 10c. The cutter support elements 14c, 16c are interconnected by means of at least one connecting element 18c of the cutting assembly 12c, which terminates at least substantially flush with at least one outer face 22c, 24c of one of the at least two cutter support elements 14c, 16c (FIG. 10). In this case, the connecting element 18c, considered along a transverse axis of the connecting element 18c, terminates flush with both outer faces 22c, 24c of one of the at least two cutter support elements 14c, 16c. The transverse axis of the connecting element 18c runs, in a state in which the cutter support elements 14c, 16c are coupled to one another, at least substantially perpendicular to a cutting plane of the cutting assembly 12c. The connecting element 18c is formed in one piece with one of the two cutter support elements 14c, 16c. In this case, the connecting element 18c is formed as a longitudinal extension of one of the at least two cutter support elements 14c, 16c. The connecting element 18c formed as a longitudinal extension extends at least substantially along a longitudinal extension of the cutter support element 14c, with which the connecting element 18c is formed in one piece. In this case, the longitudinal extension is formed in a hook-shaped manner. Each cutter support element 14c, 16c of the cutting assembly 12c of the power tool separation device 10c has a connecting element 18c, 20c formed as a longitudinal extension and a connecting recess 64c, 66c formed in a manner corresponding to the connecting element 18c. In order to form the cutting assembly 12c formed as a cutting chain, the individual connecting elements 18c, 20c of the cutter support elements 14c, 16c are each provided so as to produce, by means of a corporation with a connecting recess 64c, 66c, a form-locked connection between the cutter support elements 14c, 16c, by means of which the cutter support elements 14c, 16c are pivotably interconnected.

Furthermore, the connecting element 18c formed as a longitudinal extension has a transverse securing region 114c on one side. The transverse securing region 114c is provided so as to at least largely prevent, by means of a cooperation with at least one transverse securing element 118c, 120c, a transverse movement of the cutter support elements 14c, 16c relative to one another along at least two oppositely directed directions in a coupled state. In this case, the transverse securing region 114c is formed as a rib. It is also conceivable however for the transverse securing region 114c to have another embodiment appearing sensible to a person skilled in the art, such as an embodiment as a groove, etc. The transverse securing region 114c is arranged on a side of the connecting element 18c facing towards a cutting element 86c formed in one piece with the cutter support element 14c. In this case, the transverse securing region 114c, considered in the cutting plane of the cutting assembly 12c, extends on the connecting element 18c in a circular-segment-shaped manner.

For transverse securing of the cutter support elements 14c, 16c by means of a cooperation of the transverse securing regions 114c, 116c with the transverse securing elements 118c, 120c, at least one of the at least two cutter support elements 14c, 16c has at least one transverse securing element 118c, 120c, which is provided to at least largely prevent a transverse movement of the cutter support elements 14c, 16c relative to one another in a coupled state. On the whole, each of the cutter support elements 14c, 16c has at least two transverse securing elements 118c, 120c, 122c, 124c. The transverse securing elements 118c, 120c, 122c, 124c are each arranged in an edge region of the respective cutter support element 14c, 16c delimiting the connecting recesses 64c, 66c. In this case, the transverse securing elements 118c, 120c, 122c, 124c are formed in one piece with the cutter support element 14c, 16c. The transverse securing elements 118c, 120c, 122c, 124c are each formed integrally on the respective cutter support element 14c, 16c by means of a stamping method. The transverse securing elements 118c, 120c, 122c, 124c, considered along a direction running at least substantially perpendicular to the cutting plane of the cutting assembly 12c, thus extend at most as far as the outer faces 22c, 24c of the cutter support elements 14c, 16c. It is also conceivable however for the transverse securing elements 118c, 120c, 122c, 124c to be formed in one piece on the respective cutter support element 14c, 16c by means of another method appearing sensible to a person skilled in the art, for example by means of a welding method, by means of an adhesive bonding method, by means of a punching method, by means of a bending method, etc.

In addition, the two transverse securing elements 118c, 120c, 122c, 124c arranged on each of the cutter support elements 14c, 16c, considered along a direction running at least substantially perpendicular to the cutting plane of the cutting assembly 12c, are arranged on sides of the cutter support elements 14c, 16c remote from one another. Furthermore, the two transverse securing elements 118c, 120c, 122c, 124c arranged on each of the cutter support elements 14c, 16c are arranged on the respective cutter support element 14c, 16c in a manner offset relative to one another. The transverse securing elements 118c, 120c, 122c, 124c, based on the cutting plane of the cutting assembly 12c, are thus arranged on the cutter support elements 14c, 16c in a manner differing from an axially symmetrical arrangement. In this case, the transverse securing elements 118c, 120c, 122c, 124c are formed as partial extensions on an edge region of the connecting recesses 64c, 66c. It is also conceivable however for the transverse securing elements 118c, 120c, 122c, 124c to have another embodiment and/or arrangement appearing sensible to a person skilled in the art, such as an embodiment in the form of webs running parallel, which delimit a groove-shaped recess in the edge region of the respective connecting recess 64c, 66c, considered along a direction running at least substantially perpendicular to the cutting plane of the cutting assembly 12c.

Furthermore, at least one of the at least two cutter support elements 14c, 16c has at least one segment guide element 126c, which is provided so as to delimit a movement of the at least one of the at least two cutter support elements 14c, 16c in a state arranged in a guide unit (not illustrated here in greater detail) of the power tool separation device 10c, considered in a direction remote from the guide unit, at least along a direction running at least substantially parallel to the cutting plane of the cutting assembly 12c. The segment guide element 126c is formed by a transverse extension, which delimits a longitudinal groove. The segment guide element 126c formed as a transverse extension extends in this case at least substantially perpendicular to the cutting plane of the cutting assembly 12c. In this case the segment guide element 126c is provided so as to cooperate, in order to delimit a movement, with a segment counter guide element (not illustrated here in greater detail) arranged on the guide unit, said segment counter guide element being formed in a manner corresponding to the segment guide element 126c. It is also conceivable however for the segment guide element 126c to have a different embodiment appearing sensible to a person skilled in the art, such as an embodiment as a rib, etc., which cooperates with a groove arranged on the guide unit to delimit a movement. Each cutter support element 14c, 16c of the cutting assembly 12c comprises a segment guide element 126c, 128c, which is provided to define a movement of the at least one of the at least two cutter support elements 14c, 16c, in a state arranged in a guide unit of the power tool separation device 10c, considered in a direction remote from the guide unit, at least along a direction running at least substantially parallel to the cutting plane of the cutting assembly 12c.

The cutter support elements 14c, 16c of the cutting assembly 12c further each have a drive face 130c, 132c, which is provided, in order to drive the cutting assembly 12c, to cooperate with the drive faces of a torque transmission element (not illustrated here in greater detail). The drive faces of the torque transmission element are formed in this case as tooth flanks. The drive faces 130c, 132c of the cutter support elements 14c, 16c are thus formed in a manner corresponding to the drive faces of the torque transmission element. When the cutting assembly 12c is driven, the tooth flanks of the torque transmission element bear temporarily against the drive faces 130c, 132c for a transmission of driving forces.

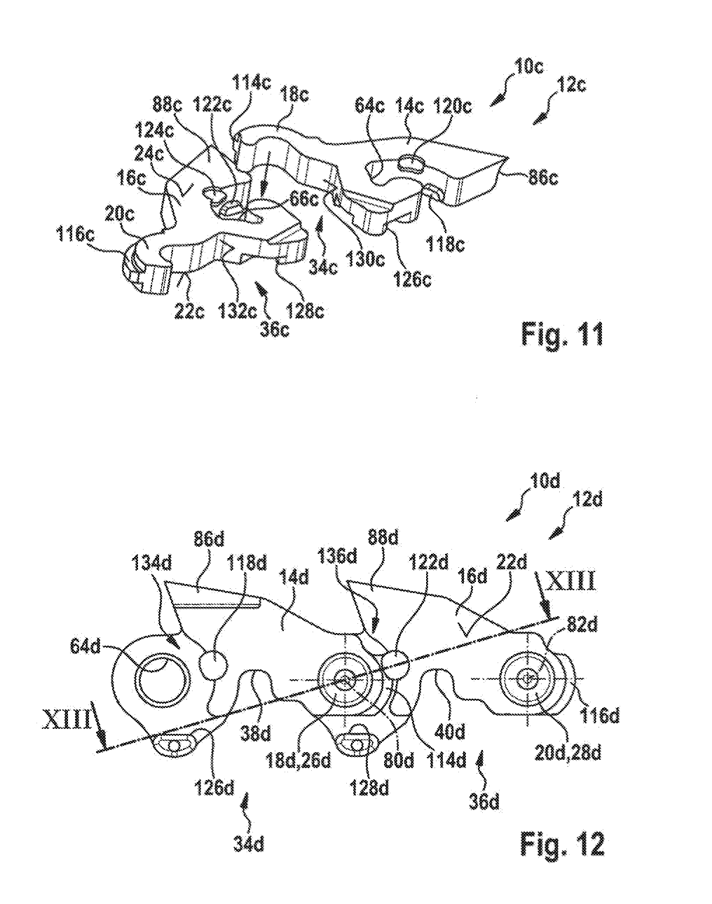

In order to assemble the cutting assembly 12c, the cutter support elements 14c, 16c are moved towards one another along a direction running at least substantially perpendicular to the cutting plane of the cutting assembly 12c (FIG. 11), wherein the connecting elements 18c, 20c are each inserted via an insertion region into the connecting recesses 64c, 66c until the outer faces 22c, 24c of the cutter support elements 14c, 16c are each arranged in a common plane running at least substantially parallel to the outer faces 22c, 24c. The cutter support elements 14c, 16c are then pivoted relative to one another about a pivot axis running substantially perpendicular to the cutting plane of the cutting assembly 12c until the transverse securing regions 114c, 116c are each slid between the transverse securing elements 118c, 120c, 122c, 124c or until the insertion regions of the connecting elements 18c, 20c contact the connecting recesses 64c, 66c along edge regions delimiting the longitudinal extension of the cutter support elements 14c, 16c. The cutter support elements 14c, 16c are thus mounted so as to be pivotable relative to one another by means of a cooperation of the connecting elements 18c, 20c and the connecting recesses 64c, 66c.

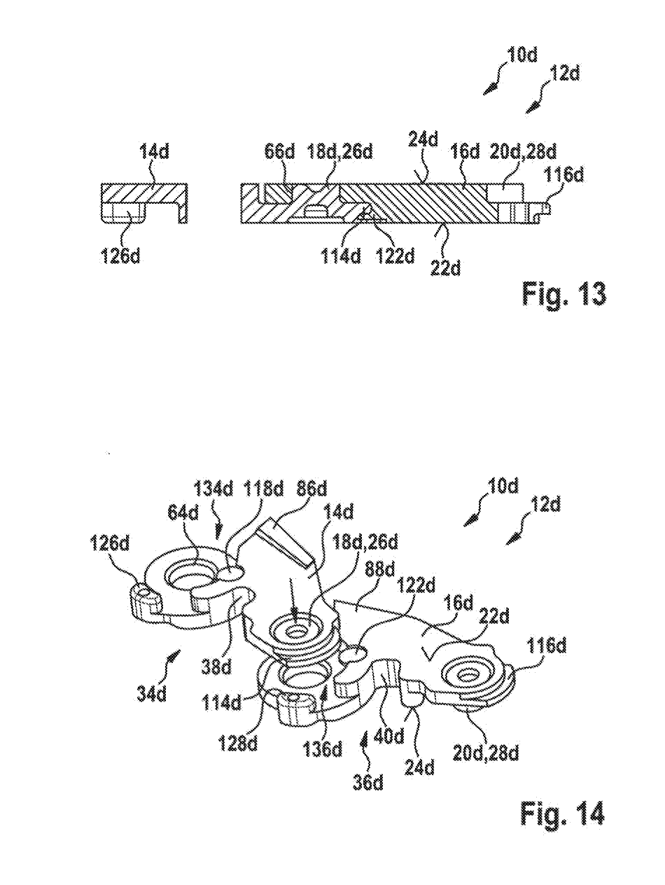

FIG. 12 shows two cutter support elements 14d, 16d, coupled to one another, of a cutting assembly 12d of a further, alternative power tool separation device 10d. The cutter support elements 14d, 16d are interconnected by means of at least one connecting element 18d of the cutting assembly 12d, which terminates at least substantially flush with at least one outer face 22d, 24d of one of the at least two cutter support elements 14d, 16d (FIG. 13). In this case, the connecting element 18d, considered along a longitudinal axis of the connecting element 18d, terminates flush with an outer face 22d of one of the at least two cutter support elements 14d, 16d. The longitudinal axis of the connecting element 18d extends at least substantially perpendicular to a cutting plane of the cutting assembly 12d. Furthermore, the connecting element 18d is formed in one piece with at least one of the at least two cutter support elements 14d, 16d. The connecting element 18d is formed in this case as a pin 26d. The pin 26d extends along a direction running at least substantially perpendicular to a cutting plane of the cutting assembly 12d. Each cutter support element 14d, 16d of the cutting assembly 12d of the power tool separation device 10d has at least one connecting element 18d, 20d formed as pins 26d, 28d and a connecting recess 64d, 66d formed in a manner corresponding to the connecting element 18d, 20d. To form the cutting assembly 12d formed as a cutting chain, the individual connecting elements 18d, 20d of the cutter support elements 14d, 16d are each provided so as to produce, by means of a cooperation with a connecting recess 64d, 66d, a form-locked connection between the cutter support elements 14d, 16d, by means of which the cutter support elements 14d, 16d are interconnected pivotably.

Furthermore, the cutter support elements 14d, 16d each have at least one transverse securing element 118d, 122d, which is provided to at least largely prevent a transverse movement of the cutter support elements 14d, 16d relative to one another in a coupled state. In addition, the cutter support elements 14d, 16d have a transverse securing region 114d, 116d. The transverse securing regions 114d, 116d are each formed in a manner corresponding to the transverse securing elements 118d, 122d in order to at least largely prevent, by means of a cooperation with the transverse securing elements 118d, 122d, a transverse movement of the cutter support elements 14d, 16d in a coupled state. The transverse securing elements 118d, 122d are formed as extensions. In this case, the transverse securing elements 118d, 122d are each arranged in a coupling region 134d, 136d of the cutter support elements 14d, 16d. The transverse securing elements 118d, 122d together with the respective coupling region 124d, 136d thus delimit a groove-shaped recess running at least substantially parallel to the cutting plane of the cutting assembly 12d and intended to receive the respective transverse securing region 114d, 116d in a coupled state of the cutter support elements 14d, 16d. The connecting recesses 64d, 66d, into which the connecting elements 18d, 20d are introduced so as to produce a form-locked connection during assembly of the cutting assembly 12d, are arranged in the coupling regions 134d, 136d. The transverse securing elements 118d, 122d are formed in one piece with the cutter support elements 14d, 16d. In this case, the transverse securing elements 118d, 122d are each formed in one piece on the respective cutter support element 14d, 16d by means of a stamping method. The transverse securing elements 118d, 122d, considered along a direction running at least substantially perpendicular to the cutting plane of the cutting assembly 12b, thus extend at most as far as the outer faces 22d, 24d of the cutter support elements 14d, 16d. It is also conceivable however for the transverse securing elements 118d, 122d to be formed integrally on the respective cutter support element 14d, 16d by means of another method appearing sensible to a person skilled in the art, for example by means of a welding method, by means of an adhesive bonding method, by means of a punching method, by means of a bending method, etc.

The transverse securing regions 114d, 116d, considered along a cutting direction 52d, are each arranged on one side of the respective cutter support element 14d, 16d remote from the coupling region 134d, 136d. In this case, the transverse securing regions 114d, 116d are each formed as a rib-shaped longitudinal extension. It is also conceivable however for the transverse securing regions 114d, 116d to have another embodiment appearing sensible to a person skilled in the art, for example an embodiment as a groove, etc. The transverse securing elements 18d, 122d overlap the transverse securing regions 114d, 116d in a coupled state of the cutter support elements 14d, 16d so as to at least largely avoid a transverse movement of the cutter support elements 14d, 16d.

Furthermore, the cutter support elements 14d, 16d each have a segment guide element 126d, 128d, which is provided to delimit a movement of the cutter support elements 14d, 16d, in a state arranged in a guide unit (not illustrated here in greater detail) of the power tool separation device 10d, considered in a direction remote from the guide unit, at least along a direction running at least substantially parallel to the cutting plane of the cutting assembly 12d. The segment guide elements 126d, 128d are formed by a longitudinal groove. In this case, the segment guide elements 126d, 128d are provided, in order to delimit a movement, to cooperate with a segment counter guide element (not illustrated here in greater detail) arranged on the guide unit, said segment counter guide element being formed in a manner corresponding to the segment guide elements 126d, 128d.

In an alternative embodiment (not illustrated here) of cutter support elements, transverse securing regions are stamped directly onto the pin-shaped connecting element by means of a stamping method after a connection of the cutter support elements by means of a pin-shaped connecting element, which is formed in one piece with one of the cutter support elements. In addition, in the alternative embodiment (not illustrated here) of the cutter support elements, transverse securing elements are formed by an edge region of a respective connecting recess comprised by the cutter support elements.

In order to assemble the cutting assembly 12d, the cutter support elements 14d, 16d are moved towards one another along a direction running at least substantially perpendicular to the cutting plane of the cutting assembly 12d (FIG. 14), wherein the connecting elements 18d, 20d are each introduced into the connecting recesses 64d, 66d along the direction running at least substantially perpendicular to the cutting plane of the cutting assembly 12d until outer faces 22d, 24d of the cutter support elements 14d, 16d bear against the corresponding coupling regions 134d, 136d. The cutter support elements 14d, 16d are then pivoted relative to one another about a pivot axis running substantially perpendicular to the cutting plane of the cutting assembly 12d until the transverse securing regions 114d, 116d are each slid into the groove-shaped recesses formed by the transverse securing elements 118d, 122d and the coupling regions 134d, 136d. The cutter support elements 14d, 16d are thus mounted so as to be pivotable relative to one another by means of a cooperation of the connecting elements 18d, 20d and the connecting recesses 64d, 66d.

1. A power tool separation device comprising:
at least one cutting assembly having at least two cutter support elements, adjacent ones of the at least two cutter support elements directly connected to each other, each cutter support element including a cutting element integral therewith, the cutting elements of the at least two cutter support elements defining a cutting plane, and
at least one guide unit configured to receive the cutting assembly,
wherein adjacent cutter support elements of the at least two cutter support elements are directly connected by at least one connecting element, said connecting element formed as a pin extending between said adjacent cutter support elements transverse to the cutting plane and received within an opening defined in each of said adjacent cutter support elements, the pin terminating at least substantially flush with at least one outer face of the other of the adjacent cutter support elements,
wherein the entire connecting element is a porous structure, and
wherein the connecting element is in contact with and guided by said guide unit.

2. The power tool separation device as claimed in claim 1, wherein the connecting element is formed as a longitudinal extension of at least one of the at least two cutter support elements.

3. The power tool separation device as claimed in claim 2, wherein the longitudinal extension is hook-shaped.

4. The power tool separation device at least as claimed in claim 1, wherein the connecting element is formed as a pin.

5. The power tool separation device as claimed in claim 1, wherein at least one of the at least two cutter support elements has at least one transverse securing element configured to at least largely prevent a transverse movement of the at least two cutter support elements relative to one another in a coupled state of the at least two cutter support elements.

6. The power tool separation device as claimed in claim 5, wherein the at least one transverse securing element is formed integrally on the at least one of the at least two cutter support elements by a stamping method.

7. The power tool separation device as claimed in claim 1, wherein at least one of the at least two cutter support elements has at least one segment guide element configured to delimit a movement of the at least one of the at least two cutter support elements, in a state arranged in a guide unit, considered in a direction remote from the guide unit, at least along a direction running at least substantially parallel to a cutting plane of the cutting assembly.

8. The power tool separation device as claimed in claim 1, further comprising:
at least one guide unit configured to receive the cutting assembly,
wherein the connecting element is guided at least in part in said guide unit.

9. The power tool separation device as claimed in claim 8, wherein the at least one guide unit includes at least one torque transmission element mounted at least in part in the at least one guide unit.

10. The power tool separation device as claimed in claim 9, wherein:
at least one of the at least two cutter support elements, on a side of the cutter support element facing towards the torque transmission element, has at least one recess, and
in at least one operating state, the torque transmission element engages the at least one recess to drive the cutting assembly.

11. The power tool separation device at least as claimed in claim 9, wherein at least one of the at least two cutter support elements is formed at least substantially in a circular-arc-shaped manner on a side of the cutter support element facing towards the torque transmission element.

12. The power tool separation device as claimed in claim 1, wherein the connecting element includes a porous structure.

13. A portable power tool comprising:
a coupling device; and
a power tool separation device having at least one cutting assembly having at least two interconnected cutter support elements, each cutter support element including a cutting element integral therewith, the cutting elements of the at least two cutter support elements defining a cutting plane, and at least one guide unit configured to receive the cutting assembly,
wherein adjacent cutter support elements of the at least two cutter support elements are directly connected by at least one connecting element, said connecting element formed as a pin extending between said adjacent cutter support elements transverse to the cutting plane and received within an opening defined in each of said adjacent cutter support elements, the pin terminating at least substantially flush with at least one outer face of the other of the adjacent cutter support elements,
wherein the connecting element is in contact with and guided by said guide unit,
wherein the entire connecting element is a porous structure, and
wherein the coupling device is coupled to the at least one guide unit by at least one of a form-locked coupling and a forced-locked coupling.

14. A power tool system comprising:
a portable power tool having a coupling device; and
a power tool separation device having at least one cutting assembly having at least two interconnected cutter support elements, each cutter support element including a cutting element integral therewith, the cutting elements of the at least two cutter support elements defining a cutting plane, and at least one guide unit configured to receive the cutting assembly,
wherein adjacent cutter support elements of the at least two cutter support elements are directly connected by at least one connecting element, said connecting element formed as a pin extending between said adjacent cutter support elements transverse to the cutting plane and received within an opening defined in each of said adjacent cutter support elements, the pin terminating at least substantially flush with at least one outer face of the other of the adjacent cutter support elements,
wherein the connecting element is in contact with and guided by said guide unit,
wherein the entire connecting element is a porous structure, and
wherein the coupling device is coupled to the at least one guide unit by at least one of a form-locked coupling and a forced-locked coupling.
